(19) United States
(12) Patent Application Publication
(10) Pub. No.: US 2008/0190916 A1
(43) Pub. Date: Aug. 14, 2008

(54) Microwave Oven With a Phase Modulator

(75) Inventor: Gerard Beausse, Charenton (FR)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 11/911,678

(22) PCT Filed: Apr. 17, 2006
(86) PCT No.: PCT/US06/14456

§ 371 Date: Oct. 16, 2007

(30) Foreign Application Priority Data
Apr. 22, 2005 (FR) 0504052

(51) Int. Cl. H05B 6/64

(52) U.S. Cl. 219/756

(57) ABSTRACT

The invention relates to a microwave oven comprising a chamber for cooking food, the electromagnetic energy of which is provided by a set of two to four magnetrons (5, 6, 7) mounted on a wall of the chamber, the magnetrons communicating with wave-guides (65) which emerge in a common microwave mixing box (8). The box (8) comprises a face common with the oven made of a material permeable to waves and a rotary phase modulator comprising a disc provided with vanes driven by electric motor and mounted on the rear face parallel with the said transparent face.

The invention is characterised by the fact that the disc provided with vanes and the drive motor together form a unit, the said unit being detachably mounted on the rear face of the microwave mixing box.

The present invention relates to microwave ovens and in particular to so-called “grande cuisine” ovens.

Microwave ovens are formed of a chamber for cooking or heating foods consisting of a generally parallelepipedal cavity with an opening on one face. A door is mounted on hinges along one side of the opening and pivots between an open position permitting access to the cooking chamber and a closed position during operation of the oven. A means for generating hyperfrequency waves transforms electrical energy into electromagnetic energy by which the foods are heated.

Professional “grande cuisine” ovens exist of relatively large capacity, greater than 150 litres, which are combi; i.e. they combine at least heating by convection or by steam with heating by microwaves. Heating by convection is effected by means of a gas burner or of one or more electrical resistances. Heating by steam, in accordance with an example embodiment, comprises inside the cavity at least one fan associated with an electrical resistance or a gas burner with steam production. In accordance with another example, the steam is produced by an external boiler.

For high capacity ovens in particular, the means for production of hyperfrequency energy is composed of a plurality of magnetrons arranged on the sides outside the chamber.

Patent application WO 2004/032570 relates to a microwave oven provided with 2 to 4 magnetrons in a same wall. Their wave-guides communicate with a mixing box for the waves. The box is of parallelepipedal form with four walls perpendicular to the wall of the oven on which the magnetrons are mounted. The wave-guides each emerge in one of the said walls of the box. One of the faces of the box is common with the wall of the oven and is formed of a material permeable to microwaves, such as mica. A rotary phase modulator is mounted on the face parallel with this latter face. When the magnetrons are in operation and the modulator is driven at a high rotational velocity, this arrangement permits generation of a wide range of simultaneous frequencies in the cooking chamber.

As shown in FIG. 2 of the patent application WO 2004/032570, the phase modulator is mounted on the rear face of the box with, on one side, the disc provided with vanes rotating inside it and, on the other, the assembly formed by the electric drive motor and the organs for stopping the electromagnetic waves. The rear face of the box is traversed by a shaft which is both driven by the motor and drives the vaned disc. To the extent that the box is firmly attached to the wall of the oven, this assembly thus provided has the disadvantage of not being simple to produce. In fact, it is necessary to have access through the interior of the oven and to remove the separation glass between the box and the oven, and also to have access to the piece from outside the oven.

The present invention is intended to improve and simplify the mounting of the phase modulator device on the microwave mixing box.

In accordance with the invention, this aim is attained with a microwave oven comprising a chamber for cooking food, the electromagnetic energy of which is supplied by a set of two to four magnetrons communicating with wave-guides which emerge in a common microwave mixing box, the microwave mixing box including a face common with the oven made of a transparent material permeable to the waves, a rotary phase modulator comprising a disc, provided with vanes, driven by electric motor and mounted on the rear face parallel with the said transparent face. This oven is characterised by the fact that the disc provided with vanes and the drive motor together form a unit, the said unit being detachably mounted on the rear face of the microwave mixing box.

Unit means an assembly which can be handled and mounted on the oven as a single piece without it being necessary to disassemble it. Due to this arrangement, in unit form, of the phase modulator, maintenance of the oven is easier and the operation of changing a part of the phase modulator is quicker to perform.

In accordance with another characteristic, the unit includes a block forming an organ for stopping electromagnetic waves, interposed between the motor and the disc with vanes. Preferably, the unit is fixed to the rear face of the box by means of the said block.

More particularly, the vaned disc comprises a disc with first vanes on the face turned towards the oven chamber for diffusion of electromagnetic waves and second vanes on the opposite face forming a valve.

Other characteristics will become apparent on reading the description of an embodiment of the invention with reference to the drawings in which

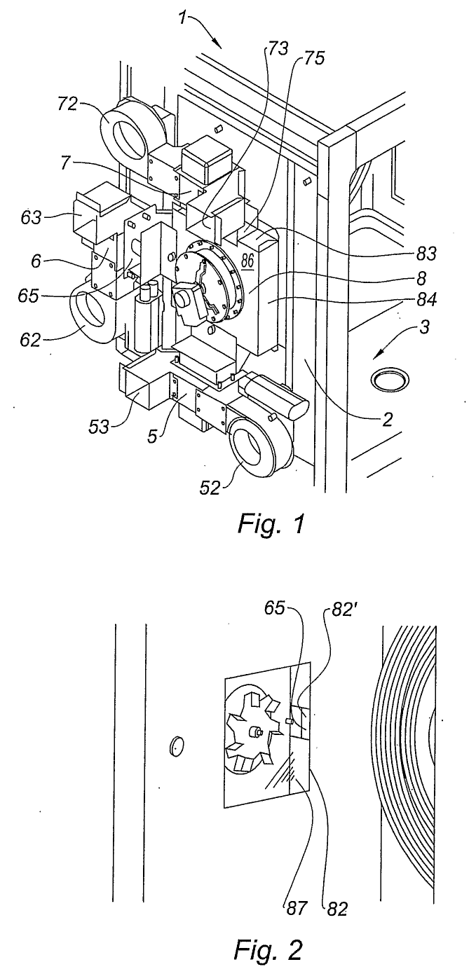

FIG. 1 is a partial view of the outside, in perspective, of a microwave oven in accordance with the invention,

FIG. 2 is a partial view of the inside, in perspective, of the oven to which the invention is applied,

FIGS. 4 and 5 show the unit in perspective.

Referring to FIG. 1, the oven 1 is seen in three quarters front perspective. The casing of the oven 1 includes a vertical wall 2 to the left of the opening giving access to the chamber for cooking food which is shown in part. On this wall 2, on the outside, are placed the magnetrons 5, 6 and 7 forming the source of electromagnetic energy. In accordance with this embodiment, the energy source is formed of three magnetrons. There may be from two to four of these. The magnetrons are each provided with a cooling device comprising a fan 52, 62 and 72 for supply of air and a conduit 53, 63 and 73 for evacuation of the air. The magnetrons are each in communication with a wave-guide 55, 65 and 75 respectively. The wave-guides emerge in a microwave mixing box 8 as is described in the patent application WO 2004/032570. The box 8 comprises four walls perpendicular to the wall of the oven 2, and a rear face or back 86 parallel with the latter. FIG. 1 shows two walls 83 and 84. As shown in FIG. 2, the box is seen from the inside of the oven chamber through a transparent wall 87 permeable to microwaves, made of mica for example. FIG. 2 shows an opening 82′ in the vertical wall 82 through which the wave-guide 65 of the magnetron 6 communicates with the inside of the microwave mixing box 8. The others are not shown, but they are arranged on the other faces in similar manner.

Inside the box, a phase modulator 10 comprises a disc 11 with vanes. The disc is parallel with the plane of the back 86 of the box.

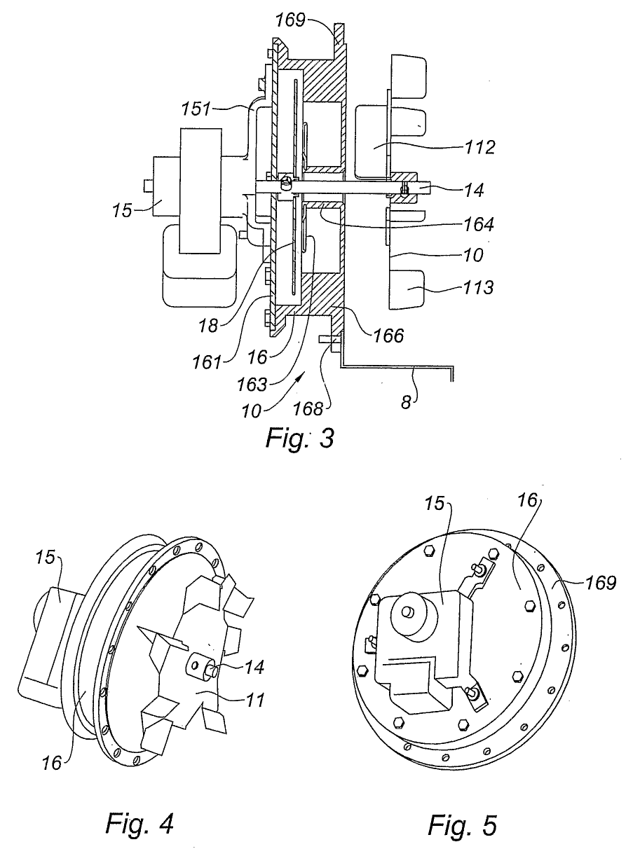

FIG. 3 shows the unit in accordance with the invention, in section through a plane passing through the axis of the drive shaft. It comprises a disc 11 provided with vanes 113 on the front face turned towards the inside of the oven and with vanes 112 on its rear face. The disc 11 is mounted on the end of a shaft 14 which is perpendicular to the rear face 86, the opposite end of which is driven by an electric motor 15. The shaft passes through a fixed, non-rotating block 16. The motor is fixed to the block 16 by three arms 151 bolted onto a plate 161, itself firmly attached to the block 16. The block 16 is circular in form and is fixed to the rear face 86 of the box 8 by a plurality of bolts 168 on a flange 169 formed on its periphery. The circular opening formed in the rear face 86 of the box 8 corresponds substantially to the diameter of the flange 169 of the block 16; it is sufficient to allow passage of the disc 11.

Inside the block 16, forming a stop block for the electromagnetic waves, are found the stop elements similar to those described in the patent application cited above, namely a rotary stop disc 18 firmly attached to the shaft 14, a fixed disc 163, a ring 164 and a wall 166.

The elements 14, 15 and 16 together form a unit which is fixed onto the rear face 86 by bolts 168. The bolts can also be screws welded to the rear face 86. Any fixing means within the scope of the man skilled in the art is suitable.

FIGS. 4 and 5 are overall views from two different angles of the unit 10 forming the phase modulator.

It is handled as one piece. When necessary, it is sufficient to unscrew the bolts 168 from the outside of the oven and to withdraw the assembly 10. This can then be worked on more conveniently on the bench. It has not been necessary to remove the glass 87.

1. Microwave oven comprising:
a chamber for cooking food, the electromagnetic energy of which is provided by a set of two to four magnetrons mounted on a wall of the chamber, the magnetrons communicating with wave-guides, which emerge in a common microwave mixing box, the box including:
a face common with the oven made of a material permeable to waves, and
a rotary phase modulator comprising a disc provided with vanes driven by an electric motor and mounted on the rear face of the box parallel with said transparent face, wherein the disc provided with vanes and the drive motor form a unit, said unit being detachably mounted on the rear face of the microwave mixing box.

2. Oven as described in claim 1, the unit of which includes a block forming a stop means for the electromagnetic waves interposed between the motor and the vaned disc.

3. Oven as described in claim 2, the unit of which is fixed to the rear face of the box by means of said block.

4. Oven as described in claim 1, the vaned disc of which comprises a disc with first vanes, on the face turned towards the oven chamber, for diffusion of electromagnetic waves and second vanes on the opposite face forming a valve.

5. A microwave oven, the oven comprising:
a chamber for cooking food;
a plurality of magnetrons mounted on the wall of the chamber to provide electromagnetic energy to the chamber, wherein the magnetrons communicate with waveguides emerging from a microwave mixing box; and
the microwave mixing box, comprising:
a front face made of material permeable to waves and exposed to the chamber;
a rear face parallel to the front face; and
a rotary phase modulator in the form of a unit detachably mounted on the rear face of the box, the unit including a disc provided with vanes and an electric motor that drives the disc.
